(19) United States
(12) Patent Application Publication
(10) Pub. No.: US 2006/0206524 A1
(43) Pub. Date: Sep. 14, 2006

(54) Intelligent collection management

(75) Inventor: Matthew B. MacLaurin, Woodinville, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/079,611

(22) Filed: Mar. 14, 2005

(51) Int. Cl. G06F 17/00

(52) U.S. Cl. 707/104.1

(57) ABSTRACT

A data organization system that facilitates altering a structure of an item (e.g., query result set, file system directory view, list, folder) in a data storage component. The system includes an operation selection component that converts a manipulation request (e.g., high-level) into a collection management (e.g., low level) operator thus shielding a user from the semantics associated with containment topology and structure. The conversion of the data manipulation request into the collection management operator is effected via a mapping component that maps the collection management operator to a low-level collection management operator based upon a type or containment topology. Accordingly, the low-level management operator modifies the structure of the item and/or file system.

### CROSS-REFERENCE TO RELATED APPLICATION(S)

This application claims the benefit of U.S. Provisional Patent Application Ser. No. ______, filed on Feb. 28, 2005, and entitled “INTELLIGENT COLLECTION MANAGEMENT,” the entirety of which is incorporated herein by reference.

### TECHNICAL FIELD

This invention is related to computer systems and more particularly to a system and method to efficiently and comprehensively manage data stores by employing high-level intelligent operators which generate low-level intelligent operators to manage the structure of items in a data store.

### BACKGROUND OF THE INVENTION

In the past, file systems for storing user data had a very simplistic object model consisting of files and straightforward containers known as “directories” and “folders.” Because of their simplicity, conventional user interfaces require only a limited set of user operators (e.g., verbs) such as move, delete, add, rename and copy data items (e.g., files). In emerging file systems today, complex container types are becoming increasingly common. These new container types include queries, hyperlinked containers, compound document objects, etc.

Existing container management operator (e.g., verb) semantics do not adequately address the complex structure and/or container topology of these new container types. Moreover, these new containers can be combined in complex ways, further challenging existing management verbs. Furthermore, the user interfaces (UIs) designed in connection with conventional storage systems cannot address this expanding functionality and complexity of the emerging dynamic containers. To this end, it would advantageous for such a UI to be approachable by non-technical end users in order to address limitations brought about by marketplace acceptance with respect to the emerging container types.

With the technological advances in computing systems and more particularly in the organization of data related to file management systems, there is an ongoing and increasing effort to implement comprehensive mechanisms to dynamically organize and/or manage data. Moreover, there is an ongoing and increasing effort to introduce new and innovative techniques for dynamically employing association identifiers to data within the operating system environment. These techniques can increase the comprehensibility and efficiency of operating and storage systems.

As briefly discussed supra, modern desktop computer systems employ a structure of simplistic hierarchical and nested containers (e.g., directories or folders) as the primary organizational mechanism. The hierarchical containers are structured such that data items and component(s) (e.g., file(s)) are physically stored in connection with a specified container. As a result, it is not possible to retain or access the identical file via multiple containers. This inability to retain or access the identical file via multiple containers makes the implementation of management operators (e.g., verbs) a very straightforward and understandable task—even by non-technical users.

Recent developments have been directed to dynamic storage facilities. These dynamic storage facilities include a list, a file system directory view and a query. In each model, the data items (e.g., files) can be stored in a centralized location(s) whereby, associations can be employed to “point to” a particular item. In this manner, multiple associations can “point to” the same item contained in a centralized store. As such, multiple dynamic containers (e.g., lists, queries) can contain the same data item (or association thereto). As well, conventional storage containers (e.g., directories, folders) can be employed in connection with dynamic lists. This complex arrangement of associations and references of the dynamic containers makes the implementation of management operators (e.g., verbs) a very complicated and abstract concept—especially for the non-technical user.

Today, with regard to conventional storage containers, there are well-known and straightforward verbs or manipulation operators that a user can employ to alter the content of a container. By way of example, a user can direct a system to “delete” a single item or a folder and all of the contents therein. As well, “add,” “move,” “copy” or the like can be employed to alter the structure of the items.

On the other hand, with the advent of dynamic containers, these conventional verbs and/or operators are not sufficient in that they do not account for the concepts of complex (e.g., recursive) associations. Rather, the conventional verbs are solely directed to manipulating an actual file within a container. In other words, in a dynamic list scenario, a problem would occur by deleting a list that contained a link to another list. Because recursive actions are a common feature of the dynamic data structures, there is a need for a novel system and/or methodology to manage the structure of the dynamic container accordingly.

Further, a substantial need exists for a novel set of storage management operators (e.g., verbs) that addresses the operations that users are likely to conduct on such complex container systems. Due to the inherent complexity of the dynamic container, a need exists to provide a high-level storage verb set which allows non-technical users to specify an abstract operation which is then translated into low-level verbs based on the object types involved. In other words, there is a substantial unmet need to provide a high-level system and/or methodology that shields a user from the low-level operating semantics of manipulating collections which contain dynamic containers.

### SUMMARY OF THE INVENTION

The following presents a simplified summary of the invention in order to provide a basic understanding of some aspects of the invention. This summary is not an extensive overview of the invention. It is not intended to identify key/critical elements of the invention or to delineate the scope of the invention. Its sole purpose is to present some concepts of the invention in a simplified form as a prelude to the more detailed description that is presented later.

Modern operating systems provide a folder or directory mechanism, which allows users to organize their files into a hierarchy of nested containers. Recent developments in file system organization have been directed to the list and dynamic list which employ associations (e.g., pointers) to represent data items in a file system. The subject invention, in various aspects thereof, is directed to a system and/or methodology of managing these new (and old) container types. More particularly, the aspects of the subject invention are directed to management operators that can be employed to alter the structure of these emerging container types.

In accordance with aspects of the subject invention, management operators can be employed to alter the structure of file systems that contain both conventional directory and folder items as well as association containers (e.g., lists) that are represented by a set of virtual association components (e.g., identifiers). Each association component can be linked to and/or point to a defined data component. The data component can be stored in a data-set component or file system in any arbitrary location. More particularly, the subject invention is directed to a system and/or method that facilitates intelligent management of the structure of any data or file system configuration (e.g., directory, folder, list, query).

In one aspect, a data storage component, an operation selection component, and a data manipulation component are provided. The data storage component can include any number of containers and/or collections. As well, the data storage component can include dynamic collections (e.g., lists, queries) as well as conventional containers (e.g., folders). The operation selection component and the data manipulation component can be employed to alter the structure and/or existence of these individual collections, containers and items.

The operation selection component can be employed to receive a data manipulation request (e.g., high-level management operator) from a user and/or application. This high-level management operator shields the user from the complex semantics of the association container and management thereof. In accordance with an aspect of the subject invention, once a specific “high-level” operation is selected by a user and/or application, the system can be employed to convert (e.g., map) the high-level operation into a low-level operation that conforms to the target structure or containment topology. In alternative aspects, rule-based logic and artificial intelligence techniques and mechanisms can be employed to automate the conversion (e.g., mapping) to a low-level collection management operator.

The collection management operator can be a function that deletes, associates, disassociates and duplicates items within a file system. Additionally, aspects of the invention are directed to collection management operators capable of factoring recursive relationships based upon file system criteria (e.g., manipulation request and item type).

To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

### BRIEF DESCRIPTION OF THE DRAWINGS

FIG. 1 illustrates a general component block diagram of a system that effects management of a file system in accordance with an aspect of the subject invention.

FIG. 2 illustrates an exemplary flow chart of procedures to generate a low-level operator in accordance with a disclosed aspect.

FIG. 3 illustrates a general block diagram that illustrates a detailed representation of a data storage and operation selection component in accordance with an aspect of the subject invention.

FIG. 4 illustrates a general block diagram that illustrates a detailed representation of a data manipulation component including a mapping component in accordance with an aspect of the subject invention.

FIG. 5 illustrates a general component block diagram of an exemplary file system structure and/or containment topology in accordance with an aspect of the subject invention.

FIG. 6 illustrates a mapping component including rule-based mechanisms in accordance with an aspect of the invention.

FIG. 7 illustrates a mapping component including artificial intelligence-based mechanisms in accordance with an aspect of the invention.

FIG. 8 illustrates a component diagram of an exemplary computing environment in accordance with an aspect of the subject invention.

FIG. 9 illustrates a block diagram of a computer operable to execute the disclosed architecture.

FIG. 10 illustrates a schematic block diagram of an exemplary computing environment in accordance with the subject invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention can be practiced without these specific details. In other instances, well-known structures and devices are shown in block diagram form in order to facilitate describing the subject invention.

As used in this application, the terms “component” and “system” are intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

As used herein, the term to “infer” or “inference” refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

As discussed supra, conventional operating systems employ a folder and/or directory storage technique that permits a user to organize files into a hierarchy of nested containers. In other words, the folder and directory mechanisms are directed to techniques whereby data is physically arranged into a hierarchical, nested and/or tree-like structure. By contrast, the emerging dynamic collection techniques discussed supra introduces novel container types (e.g., list and dynamic list) based upon mapping and other association techniques.

A “list” can be a container of mapping identifiers (e.g., associations). In contrast to a folder, a single file can be referenced and accessed in any number of lists. As well lists can be arranged in an arbitrarily complex graph of relationships. The items (e.g., identifiers) in a list can be chosen arbitrarily by the user or other application (e.g., software program) and need not have any properties in common.

A “dynamic list” can be a collection of files that is built and maintained automatically by the system for the user. Dynamic lists can be based on queries. In other words, the system can execute a query against a file store whereby identifiers associated to the resulting files are added to the dynamic list. In accordance with the query operation, if a characteristic of the data component changes, the association to such a data component can be updated, modified or removed from the dynamic list. By way of example, if a data component changes whereby it no longer matches the results of the query, the system can dynamically and/or automatically update the list to reflect the changes.

In addition to the general functionality of altering the structure of the “list” and “dynamic list”, the subject invention, in various aspects thereof, provides for a system and/or methodology that enables altering the structure of combinations of container types. By way of example, a list can contain identifiers corresponding to folders and dynamic lists. Alternatively, a folder can contain lists and dynamic lists. Further, a dynamic list can contain identifiers to folders and lists. Although aspects of the subject invention are directed to the manipulation of the structure of the configuration of a list and/or dynamic list, it is to be appreciated that lists and dynamic lists can include associations to any type of data components, or combination thereof, known in the art. As such, the features and novel concepts discussed herein can be applied to any structure of data items known in the art.

In accordance with aspects of the subject invention, management operators can be employed to alter the structure of association containers (e.g., lists) that are represented by a set of virtual association components (e.g., identifiers). Each association component can be linked to and/or point to a defined data component. The data component can be stored in a data-set component or file system in any arbitrary location. More particularly, the subject invention is directed to a system and/or methodology that facilitates intelligent management of the structure of any data configuration (e.g., directory, folder, list, query).

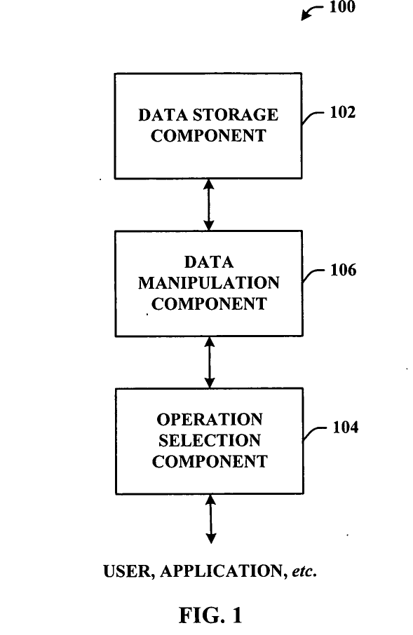

Referring now to FIG. 1, there is illustrated a schematic representation of an aspect of a system 100 that facilitates managing the organizational structure of data in accordance with the subject invention. Generally, the system 100 can include a data storage component 102, an operation selection component 104 and a data manipulation component 106.

As will be discussed in greater detail infra, the data storage component 102 can include any number of containers and/or collections. As well, the data storage component 102 can include dynamic collections (e.g., lists, queries). In addition to the associations of the dynamic collections, the data storage component 102 can include conventional containers (e.g., folders, directories) as well as data items. The operation selection component 104 and the data manipulation component 106 can be employed to alter the structure and/or existence of these individual collections, containers and items. As illustrated, a user and/or application can effect the management and/or modification of the structure.

The operation selection component 104 can be employed to receive a data manipulation request from a user and/or application as shown. This data manipulation request can be high-level request thus shielding the user from the complex semantics and structure corresponding to the association container. By way of example, a data manipulation request can be employed to “delete” a specified association and/or list. To a user, this “delete” operation can be readily understood as simply removing an item. Rather, because of the inherent complexity of the association containers, the simple “delete” operation can have significant implications if it were simply to be executed as a commonly known “delete” operation.

In accordance with an aspect of the subject invention, once a specific “high-level” operation (e.g., “delete”) is selected by a user and/or application, the data manipulation component 106 can be employed to convert the high-level operation into a low-level operation that conforms to the target structure. In other words, the operation selection component 104 shields the user from complex semantics of the management operators applicable to the data storage component 102. The data manipulation component 106 converts this high-level management operator into a low-level management operator based upon the manipulation request and type of the target node. These concepts will be better understood following a discussion of the features, including recursive features, of the dynamic collection described infra.

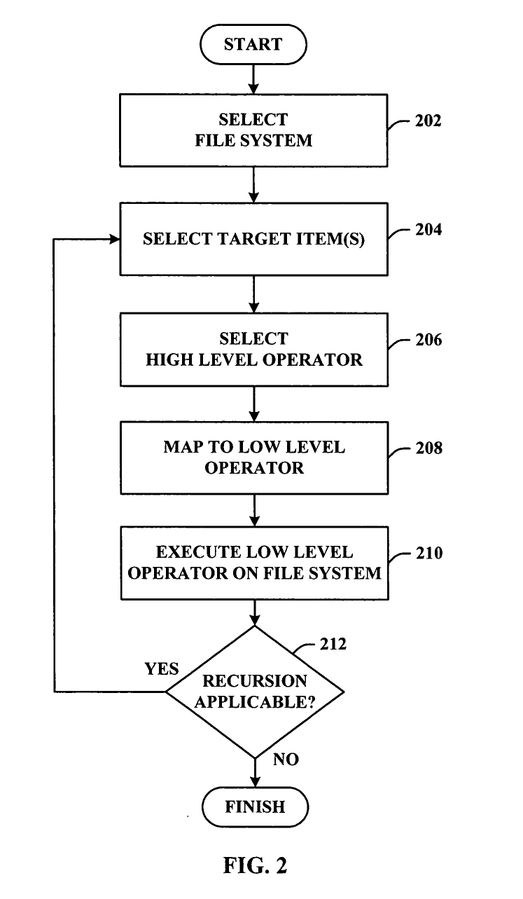

With reference to FIG. 2, there is illustrated a flow chart in accordance to an aspect of the subject invention. While, for purposes of simplicity of explanation, the one or more methodologies shown herein, e.g., in the form of a flow chart, are shown and described as a series of acts, it is to be understood and appreciated that the subject invention is not limited by the order of acts, as some acts may, in accordance with the subject invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the subject invention.

Referring again to FIG. 2, at 202, a file system or data storage component is selected. At 204, the desired target items (e.g., data components, lists) can be selected in accordance with a desired management operation. Once selected, at 206, a high-level management operator can be selected in accordance with the desired management operations. For example, a user can select a high-level “delete” operation to be executed upon the targeted item(s). At 208, the high-level management operator can be mapped to determine a low-level management operator. As described supra, this mapping can shield a user from the complex semantics associated with an association collection (e.g., list, query).

Although the aspects described herein employ a high-level and low-level management operator, it is to be understood that novel and functional aspects of the subject invention can be employed solely by generating a low-level management operator. In other words, the subject invention can be employed by technical users whereby the complex semantics of the low-level management operator can be directly understood without the use of a high-level management operator. Further, as described with reference to FIG. 1, the functionality of the operation selection component 104 and the data manipulation component 106 can be combined into one component whereby only a low-level verb (e.g., operator) is employed.

At 210, the operator is executed upon the target items and/or data storage component within the file system. At 212, the system can prompt to determine if recursion is applicable to the data storage component and/or target items. If so, the system returns to 204 whereby the additional target components can be selected. If an additional operation(s) is not desired, the methodology finishes. A more detailed discussion of the recursion functionality of the subject invention will be discussed infra.

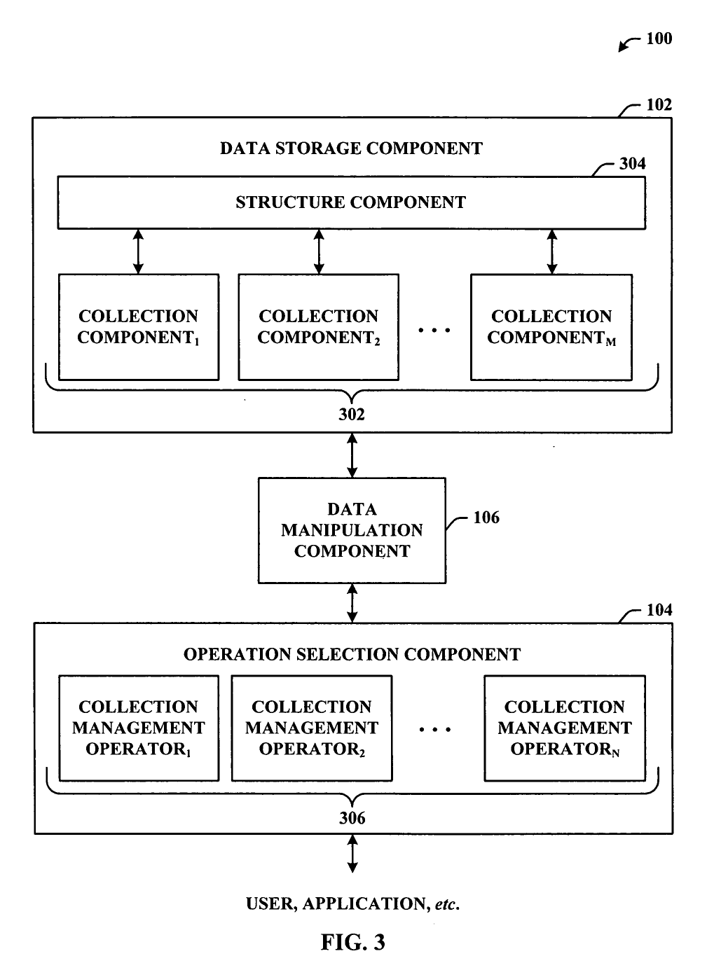

Referring to FIG. 3, there is illustrated a detailed schematic diagram of the system 100. As shown, the data storage component 102 can include collection components 1 to M, where M is an integer. Collection components 1 to M can be referred to collectively or individually as collection components 302. In accordance with aspects of the invention, collection components 302 can include any data container known in the art. For example, collection components 302 can include, but are not limited to include, file system directories, file system directory views, folders, lists, queries or the like. The structure component 304 shown in FIG. 3 is a representation of the relationship between the collection components 302. For example, contents of a list or folder can be defined by the structure component 304.

Operation selection component 104 can include collection management operators 1 to N, where N is an integer. Collection management operators 1 to N can be referred to collectively or individually as collection management operators 306. In accordance with aspects of the invention, collection management operators 306 can include any high-level management operator known in the art including, but not limited to, “delete”, “add”, “copy”, “move” or the like. The data manipulation component 106 can then be employed to convert the high-level collection management operators 306 into low-level collection management operators whereby, the low-level collection management operators can then be executed upon the data storage component 102 and structure component 304 associated therewith.

In an alternate aspect, collection management operators 306 can be representative of the low-level management operators. For example, collection management operators 306 can be representative of operators such as “delete deep”, “delete shallow”, “delete disjoint” and the like. These low (and high) level collection management operators 306 will be discussed in greater detail infra.

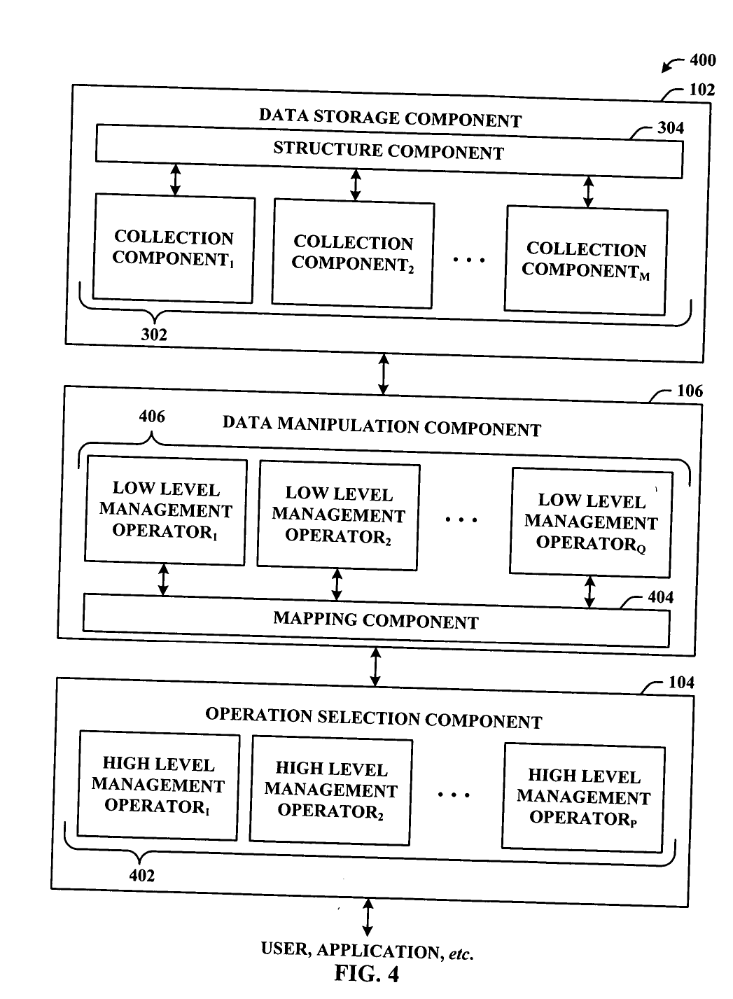

Turning now to a discussion of high-level management operators, in order to enable non-technical users to successfully use the system, FIG. 4 illustrates an alternate system 400 that employs high-level management operators 1 to P, where P is an integer, that can be provided in connection with the operation selection component 104. It is to be understood that high-level management operators 1 to P can be referred to individually or collectively as high-level management operators 402. As illustrated, mapping component 404 can be employed by the data manipulation component 106 to map the high-level management operators 402 to low-level management operators 406. As shown, the data manipulation component 106 can include 1 to Q low-level management operators, where Q is an integer. It is to be understood that low-level management operators 1 to Q can be referred to individually or collectively as low-level management operators 406.

In operation, the data manipulation component 106, via the mapping component 404, can facilitate dynamically mapping the high-level management operators 402 to the appropriate low-level management operator(s) 406. These high-level management operators 402 can include, but are not limited to “Delete”, “Add”, “Remove”, “Duplicate.” It will be appreciated that the functionality of these high-level management operators 402 can be generally easier to understand for the non-technical user.

As previously stated, the data manipulation component 106 can employ the mapping component 404 to effect conversion of a high-level management operator 402 to a low-level management operator 406 to alter the content of the data storage component 102. The mechanism for mapping high-level operations (e.g., mapping component 404) can draw information from the type of the item (e.g., data item maintained within collection component 302) which is the subject of the selected operation. Additionally, the mapping component 404 can draw information from the type of the container (e.g., collection component 302) which maintains the subject data item. Moreover, the mapping component 404 can draw information from the containment topology (e.g., structure 304) of the subject item or data storage component 102. It is to be appreciated that the mapping component 404 can employ any of these criteria (or combinations thereof) to map from a high-level management operator 402 (e.g., “Delete”) to its appropriate low-level specialization management operator 406 (e.g., “Delete Shallow”, “Delete Deep”, “Delete Disjoint”).

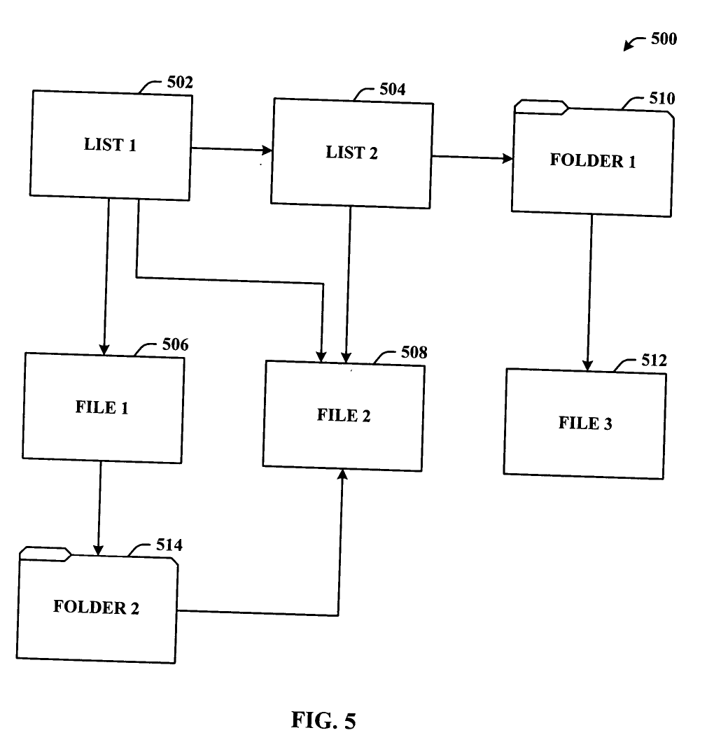

FIG. 5 is provided to add context to the invention by illustrating a representative file system structure 500. The following discussion will employ this file system structure 500 to demonstrate the novel aspect(s) of the low-level management operators 406 described herein. The low-level management operators 406 which can operate on these containers as described infra. It will be appreciated that variations of these described low-level management operators 406 can exist without departing from the spirit and scope of the novel features described herein. Further, it will be appreciated that these variations will fall within the scope of the claims appended hereto.

Turning now to a discussion of the low-level management operators 402. For ease of understanding, a function call style of documentation is described herein. It is to be understood that these low-level (and high-level) management operators can be expressed via alternate mechanisms. By way of example, the low-level management operators 406 can be expressed directly in a user interface via selection, menus, etc. The low-level management operators 406 can include, but are not intended to be limited to include, “Delete Deep”, “Delete Shallow”, “Delete Disjoint”, “Add”, “Remove”, “Duplicate Deep”, “Duplicate Shallow”, and “Duplicate Disjoint.” Each of these low-level management operators 406 will be described in greater detail below. Although the low-level management operators 406 are described herein with reference to a specific naming convention, it will be appreciated that any naming convention can be employed without departing from the scope of the subject invention.

“Delete Deep” can refer to a low-level management operator 406 that can be executed upon a container (e.g., folder, list) in the form of a function. This “Delete Deep” low-level management operator 406 can delete a target item and all items contained within it recursively. For example, with reference to FIG. 5, as shown, LIST 1 (502) includes LIST 2 (504) and associations to FILE 1 (506) and FILE 2 (508). LIST 2 (504) includes associations to FILE 2 (508) and FOLDER 1(510), which includes FILE 3 (512). FOLDER 2 (514) includes a copy of FILE 1 (506) and FILE 2 (508).

If a “Delete Deep” low-level management operation 406 is deemed to be executed upon List 1 (502), effectively FILE 1 (506), FILE 2 (508), LIST 2 (504), FOLDER 1 (510) and FILE 3 (512) will be deleted. It is important to note that in the example, FILE 3 (512) will be deleted because it is recursively contained within LIST 1 (502) via LIST 2(504) and FOLDER 1 (510). As previously described, the logic of the system can deem a “Delete Deep” operation based upon the criteria of the target item. In this example, “Delete Deep” can be employed because LIST 1 (502) includes recursive items (e.g., via LIST 2 (504)). As discussed, a high-level management operator (402) (e.g., “Delete”) can be converted (e.g., mapped) into a low-level management operator (406) (e.g., “Delete Deep”) based upon the item type, container type and/or structure specifics (e.g., containment topology).

Continuing with the example, suppose a high-level “Delete” operator is executed upon LIST 1 (502) and a “Delete Shallow” is deemed to be executed as the low-level management operator 406. In view of the container type and associations therewith, the system can map this high-level “Delete” operation to a low-level “Delete Shallow.” As well, a mechanism can be employed to prompt a user of a desired action (e.g., “Delete Deep” or “Delete Shallow”). The “Delete Shallow” operation can delete the target item, but does not delete any of the items contained within the item. In the example of FIG. 5, a “Delete Shallow” employed upon LIST 1 (502) will delete LIST 1 (502) and any associations therein. However, this low-level management operator 406 (e.g., “Delete Shallow”) will not delete that actual files and containers associated therewith, e.g., FILE 1 (506), FILE 2 (508) and/or LIST 2 will remain unaffected.

Another exemplary operator is “Delete Disjoint” which can be executed upon a container. “Delete Disjoint” can delete the target item and all items contained within it recursively except those items which are also contained in an item which is not being deleted. Continuing with the example, if a “Delete Disjoint” is effected upon LIST 1 (502), only LIST 2 (504), FOLDER 1 (510) and FILE 3 (512) will be deleted. As illustrated in FIG. 5, LIST 2 (504) is contained within LIST 1 (502) therefore LIST 2 (504) would be deleted. FILE 3 (510) is recursively contained within LIST 1 (502) (e.g., via FOLDER 1 (510) and LIST 2 (504)) therefore, it too will be deleted upon a “Delete Disjoint” operation. However, because FILE 1 (506) and FILE 2 (508) are included within FOLDER 2 (514), they would not be deleted upon a “Delete Disjoint” operation.

An “Add” low-level operator can be employed upon an item and/or container. This “Add” operation can cause the item to be contained by the given container. It will be understood that, due to the nature of the file system structure, if the subject item is in a folder and the new container is also a folder, the item will be removed from the original folder. This is because, due to the inherent characteristics of a folder, a single item cannot be contained within multiple folders. For example, if an “Add” operator is executed to add FILE 3 (512) to FOLDER 2 (514), the file can be automatically removed from FOLDER 1 (510) and placed into FOLDER 2 (514). On the other hand, if an “Add” operator is executed to add FILE 3 (512) to LIST 1 (502), FILE 3 (512) can remain in FOLDER 1 (512) whereby an association will be created to associate FILE 3 (512) to LIST 1 (502).

Another exemplary low-level operator is the “Remove” operator. This “Remove” operator can be executed upon an item and/or a container. Accordingly, this operation can cause the subject item to no longer be contained by the given container. With reference again to FIG. 5, if a “Remove” low-level operator is executed upon FILE 2 (508), this will effectively remove FILE 2 (508) from FOLDER 2 (514) as well as disassociating from LIST 1 (502) and LIST 2 (504).

As described in detail with reference to the “Delete” operations, “Duplicate” operations have the same characteristics. As with “Delete Deep,” “Duplicate Deep” can be effected upon a container. This low-level operator can duplicate the item and all items contained within it recursively. When a “Duplicate Shallow” low-level operator is executed upon a container, only the container is duplicated. This operation can cause the items contained within the container to also be contained within the new (duplicate) container. “Duplicate Disjoint” is a third “Duplicate” low-level operator that can be effected upon a container. As described with reference to “Delete Disjoint,” “Duplicate Disjoint” can duplicate the item and all items within it that are not contained within another item.

It is to be appreciated that the method of mapping to low-level operation is recursive. For example, if the high-level “Delete” operation is applied to a container and, based on specialization rules, that container invokes a “Delete Deep”, this would cause high-level “Delete” operations to be applied to each of the containers contents. The mapping process would be repeated for each of those contents. Contained items could then re-map that “delete” operation to an alternate specialization, or to no operation at all.

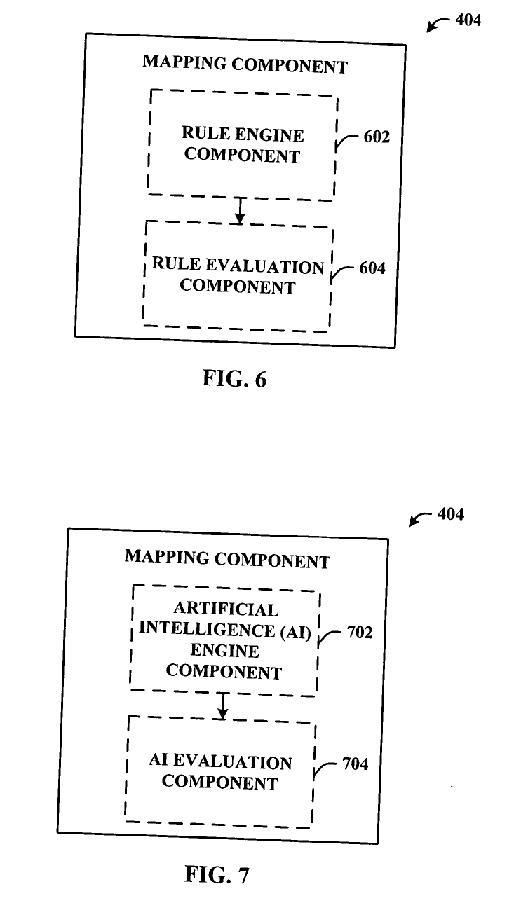

The recursive mapping functionality can be better understood with reference to the example of FIG. 5. Referring back to the example of FIG. 5, a “Delete” invoked upon LIST 1 (502) would recursively invoke the “Delete” upon LIST 2 (502). As described supra, this operation would then be remapped upon the contents of LIST 2 (502). Accordingly, low-level operators would be chosen based upon the characteristics of the individual items contained therein. It will be understood and appreciated that the invention (e.g., mapping component 404) can employ rule-based and/or artificial intelligence (AI) logic in performing operations (e.g., mapping operation). These rule-based and AI-based aspects will be described in detail with reference to FIGS. 6-9 infra.

With reference now to FIG. 6, an alternate aspect of mapping component 404 (FIG. 4) is shown. More particularly, mapping component 404 generally includes a rule engine component 602 and a rule evaluation component 604. In accordance with this alternate aspect, an implementation scheme (e.g., rule) can be applied to define and/or implement a predefined mapping scheme. It will be appreciated that the rule-based implementation can automatically and/or dynamically define and implement a scheme based upon a high-level operator. In response thereto, the rule-based implementation can select low-level operators by employing a predefined and/or programmed rule(s) based upon any desired criteria (e.g., item type, container type, containment topology (e.g., structure)).

For example, a user can establish a rule that predefines a low-level operator based upon a container type (e.g., list). In other words, a predefined rule can be employed to set a default low-level operation mapping based upon any desired criteria (e.g., container type). More particularly, in one aspect a default can be set for folders (e.g., container type) such that the system can be mapped to perform to a low level “Delete Deep” by default upon receiving a “Delete” high level operator. For queries and/or searches (e.g., web), the system can be configured to perform a “Delete Shallow” by default. Another application of rule-based logic can be to perform a “Delete Disjoint” by default for lists. It will be appreciated that the system can be set not to delete folders contained in list. On the other hand, lists contained in a folder can map delete to “no operation.”

In the exemplary aspect of FIG. 6, the rule engine component 602 can be programmed or configured in accordance with a user-defined preference. As well, a rule can be established in accordance with an overall containment topology with respect to hardware configuration. For example, a rule can be constructed in accordance with a file system structure in view of specific memory capacity. Thus, in one aspect, with respect to a specific handheld device with low memory capacity, a rule can be generated to map the high-level “Delete” operation to perform a modified version of a “Delete Deep” whereby files that exceed a predefined size threshold or files that have not been used for a predetermined period of time can be deleted. The rule evaluation component 604 facilitates application of the rule. Based upon the output of the rule evaluation component 604, the mapping component 404 can convert and map to an appropriate low level operator thus effecting data management as discussed supra.

A schematic diagram of another alternative aspect of the mapping component 404 is illustrated in FIG. 7. In addition to or in place of the rule-based components described with reference to FIG. 6, the mapping component 404 can include an AI engine component 702 and an AI evaluation component 704.

In accordance with this aspect, the optional AI engine and evaluation components 702, 704 can facilitate automatically configuring and/or implementing various aspects of the mapping component 404. The AI components 702, 704 can optionally include an inference component (not shown) that can further enhance automated aspects of the AI components utilizing, in part, inference based schemes to facilitate inferring intended actions to be performed at a given time and state. The AI-based aspects of the invention can be effected via any suitable machine-learning based technique, statistical-based techniques and/or probabilistic-based techniques.

In the alternate aspect, as further illustrated by FIG. 7, the subject mapping component 702 (e.g., in connection with mapping low-level operators) can optionally employ various artificial intelligence based schemes for automatically carrying out various aspects thereof. Specifically, an artificial intelligence engine and evaluation components 702, 704 can optionally be provided to implement aspects of the subject invention based upon artificial intelligence processes (e.g., confidence, inference). For example, a process for an appropriate low-level operator based upon container type and containment topology can be facilitated via an automatic classifier system and process. Further, the optional artificial intelligence engine and evaluation components 702, 704 can be employed to facilitate an automated process of mapping low-level operators in accordance with hardware specifications whereby a high-level operator (e.g., “Delete”) directed to a specific container type can be mapped to a particular low-level operator (e.g., “Delete Deep”) so long as particular parameters are met.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. In the case of mapping operators, for example, attributes can be item types, container types, containment topology types or other data-specific attributes derived from the types and/or contents, and the classes can be categories or areas of interest.

A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, and probabilistic classification models providing different patterns of independence can be employed. Classification as used herein also is inclusive of statistical regression that is utilized to develop models of priority.

As will be readily appreciated from the subject specification, the invention can employ classifiers that are explicitly trained (e.g., via a generic training data) as well as implicitly trained (e.g., via observing user behavior, receiving extrinsic information). For example, SVM's can be configured via a learning or training phase within a classifier constructor and feature selection module. In other words, the use of expert systems, fuzzy logic, support vector machines, greedy search algorithms, rule-based systems, Bayesian models (e.g., Bayesian networks), neural networks, other non-linear training techniques, data fusion, utility-based analytical systems, systems employing Bayesian models, etc. are contemplated and are intended to fall within the scope of the hereto appended claims.

Other implementations of AI could include alternative aspects whereby based upon a learned or predicted user intention, the system can prompt for additional and/or alternative operators to employ. Likewise, an optional AI component could prompt a user to perform a specific operation based upon any desired criteria (e.g., memory space). Moreover, AI can be used to search for commonality of containment topologies thereby recommending similar actions to enhance comprehensive storage.

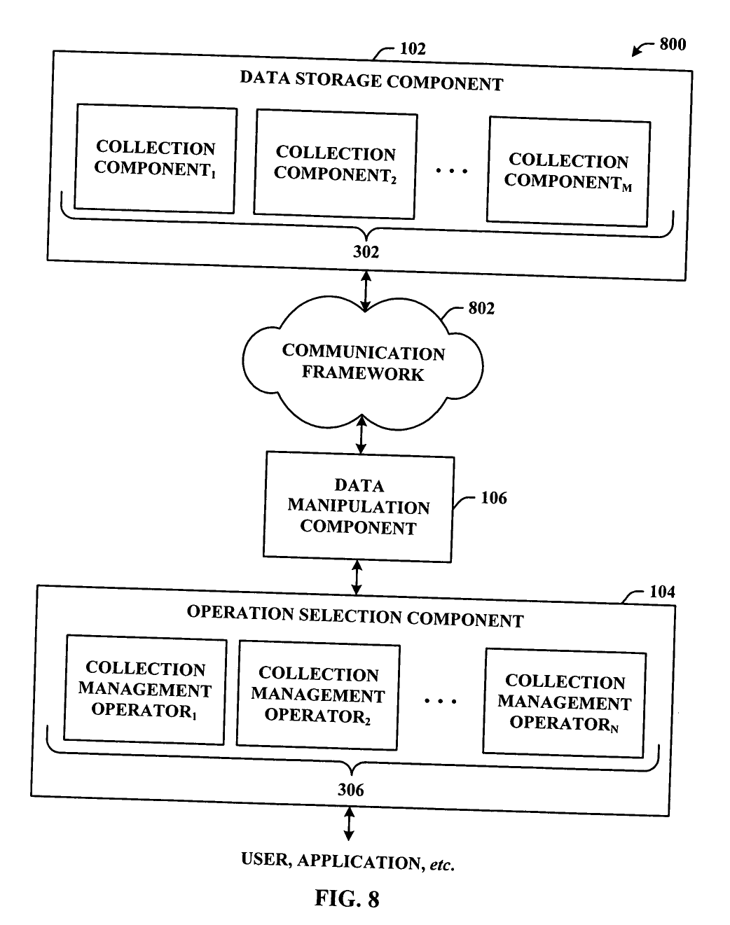

Referring to FIG. 8, a schematic block diagram of an exemplary computing environment is shown in accordance with an aspect of the subject invention. Specifically, the system 800 illustrated includes an data storage component 102 having collection components 104 contained therein. Further, the system 800 includes a data manipulation component 106 and an operation selection component 104 having collection management operators 306 therein. These components can have the same functionality as discussed in detail supra with reference to FIG. 1. Additionally, the system 800 illustrated employs a communication framework 802 whereby the data storage component 102 can be located remotely from the data manipulation component 106 and the operation selection component 104. Communications framework 802 can employ any communications technique (wired and/or wireless) known in the art. For example, communications framework 802 can include, but is not limited to, Bluetooth™, Infrared (IR), Wi-Fi, Ethernet, or the like. In this example, the data items, container and collections can be managed remotely via the portable device.

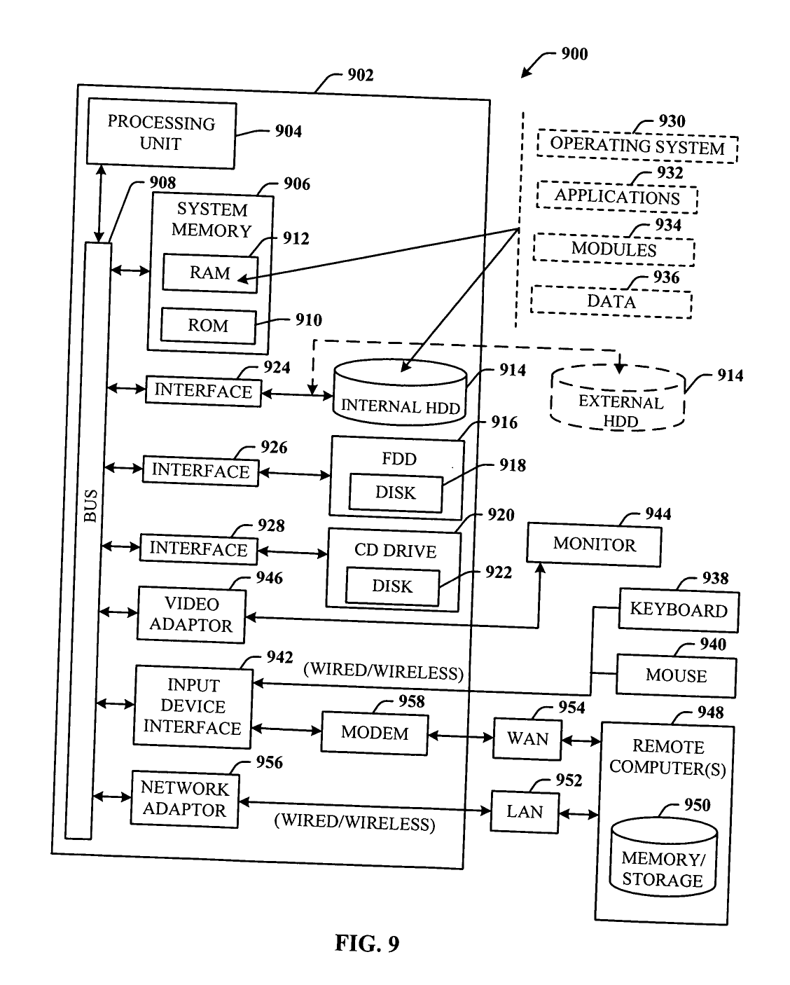

Referring now to FIG. 9, there is illustrated a block diagram of a computer operable to execute the disclosed architecture. In order to provide additional context for various aspects of the subject invention, FIG. 9 and the following discussion are intended to provide a brief, general description of a suitable computing environment 900 in which the various aspects of the subject invention can be implemented. While the invention has been described above in the general context of computer-executable instructions that may run on one or more computers, those skilled in the art will recognize that the invention also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the invention may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer readable media can comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 9, there is illustrated an exemplary environment 900 for implementing various aspects of the invention that includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors. Dual microprocessors and other multi-processor architectures may also be employed as the processing unit 904.

The system bus 908 can be any of several types of bus structure that may further interconnect to a memory bus (with or without a memory controller), a peripheral bus, and a local bus using any of a variety of commercially available bus architectures. The system memory 906 includes read only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914 (e.g., EIDE, SATA), which internal hard disk drive 914 may also be configured for external use in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE 1394 interface technologies.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the subject invention.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the subject invention can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) may include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE 1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers etc.

The computer 902 may operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices, and companies, and facilitate enterprise-wide computer networks, such as intranets, all of which may connect to a global communication network, e.g., the Internet.

When used in a LAN networking environment, the computer 902 is connected to the local network 952 through a wired and/or wireless communication network interface or adapter 956. The adaptor 956 may facilitate wired or wireless communication to the LAN 952, which may also include a wireless access point disposed thereon for communicating with the wireless adaptor 956. When used in a WAN networking environment, the computer 902 can include a modem 958, or is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with conventional network or simply an ad hoc communication between at least two devices.

Wi-Fi, or Wireless Fidelity, allows connection to the Internet from a couch at home, a bed in a hotel room or a conference room at work, without wires. Wi-Fi is a wireless technology like a cell phone that enables such devices, e.g., computers, to send and receive data indoors and out; anywhere within the range of a base station. Wi-Fi networks use radio technologies called IEEE 802.11(a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.1 a) or 54 Mbps (802.11b) data rate, for example, or with products that contain both bands (dual band), so the networks can provide real-world performance similar to the basic 10BaseT wired Ethernet networks used in many offices.

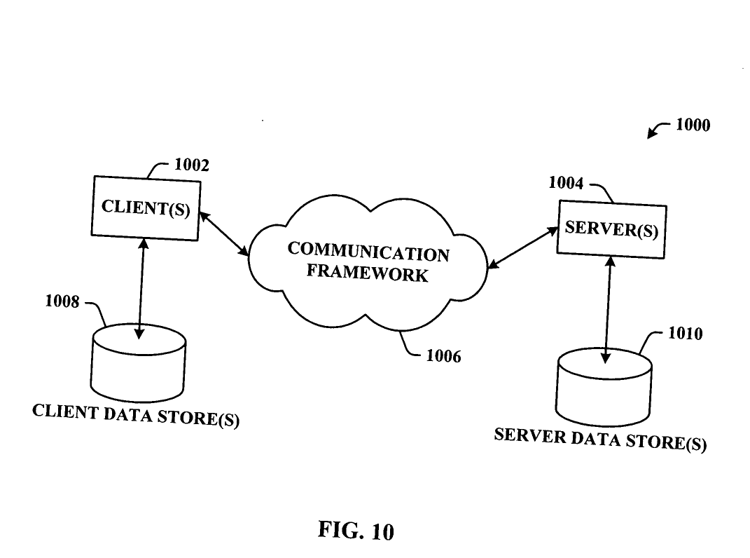

Referring now to FIG. 10, there is illustrated a schematic block diagram of an exemplary computing environment 1000 in accordance with the subject invention. The system 1000 includes one or more client(s) 1002. The client(s) 1002 can be hardware and/or software (e.g., threads, processes, computing devices). The client(s) 1002 can house cookie(s) and/or associated contextual information by employing the subject invention, for example. The system 1000 also includes one or more server(s) 1004. The server(s) 1004 can also be hardware and/or software (e.g., threads, processes, computing devices). The servers 1004 can house threads to perform transformations by employing the subject invention, for example. One possible communication between a client 1002 and a server 1004 can be in the form of a data packet adapted to be transmitted between two or more computer processes. The data packet may include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the subject invention. It is, of course, not possible to describe every conceivable combination of components or methodologies for purposes of describing the subject invention, but one of ordinary skill in the art may recognize that many further combinations and permutations of the subject invention are possible. Accordingly, the subject invention is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that facilitates altering a structure of an item in a data storage component, the system comprising:
an operation selection component that converts a manipulation request into a collection management operator; and
a data manipulation component that employs the collection management operator to alter structure of the data storage component.

2. The system of claim 1, the item is at least one of a query result set, a file system directory view and a list.

3. The system of claim 1, the collection management operator is a function that deletes a target item and a subset of items recursively associated with the target item; the subset is determined as a function of the manipulation request and a type of the target item and the associated items.

4. The system of claim 1, the collection management operator is a function that deletes a target item.

5. The system of claim 1, the collection management operator is a function that deletes a target item and a subset of items recursively associated with the target item that are not associated with an unaffected item; the subset is determined as a function of the manipulation request and a type of the target item and the associated items.

6. The system of claim 1, the collection management operator is a function that associates an item to a collection.

7. The system of claim 1, the collection management operator is a function that disassociates an item from a collection.

8. The system of claim 1, the collection management operator is a function that duplicates a target item and a subset of items recursively associated with the target item; the subset is determined as a function of the manipulation request and a type of the target item and the associated items.

9. The system of claim 1, the collection management operator is a function that duplicates a target item.

10. The system of claim 1, the collection management operator is a function that duplicates a target item and a subset of items recursively associated with the target item; the subset is determined as a function of the manipulation request and a type of the target item and the associated items.

11. The system of claim 1, the data manipulation component further comprises a mapping component that maps the collection management operator to a low-level collection management operator, the low-level collection management operator facilitates modification of the structure of the data storage component.

12. The system of claim 11, the mapping component comprises:
a rule engine component that automatically instantiates a rule that implements a predefined criteria; and
a rule evaluation component that applies the rule with respect to mapping the low-level collection management operator.

13. The system of claim 11, the mapping component comprises an artificial intelligence component that facilitates automatically selecting the low-level collection management operator as a function of historical user criteria.

14. A computer readable medium having stored thereon the components of claim 1.

15. A method of organizing a data storage component, the method comprising:
selecting a high-level collection management operator;
mapping the high-level collection management operator to a low-level management operator; and
executing the low-level collection management operator on the data storage component.

16. The method of claim 15, the act of mapping further includes determining the low-level collection management operator based upon a type.

17. The method of claim 15, the low-level collection management operator is at least one of:
a function that deletes a target item and a subset of items recursively associated with the target item;
a function that deletes a target item;
a function that deletes a target item and a subset of items recursively associated with the target item that are not associated with an unaffected item;
a function that associates an item to a collection;
a function that disassociates an item from a collection;
a function that duplicates a target item and a subset of items recursively associated with the target item;
a function that duplicates a target item; and
a function that duplicates a target item and a subset of items recursively associated with the target item, the subset is determined as a function of the manipulation request and a type of the target item and the associated items.

18. A computer readable medium having stored thereon computer executable instructions for carrying out the method of claim 17.

19. A system that facilitates altering a structure of an item in a data storage component, the system comprising:
means for selecting a high-level collection management operator;
means for converting the high-level collection management operator to a low-level management operator; and
means for altering the structure in accordance with the low-level management operator.

20. The system of claim 19, the low-level collection management operator comprises at least one of:
means for deleting a target item and a subset of items recursively associated with the target item;
means for deleting a target item;
means for deleting a target item and a subset of items recursively associated with the target item that are not associated with an unaffected item;
means that associates an item to a collection;
means for disassociating an item from a collection;
means for duplicating a target item and a subset of items recursively associated with the target item;
means for duplicating a target item; and
means for duplicating a target item and a subset of items recursively associated with the target item, the subset is determined as a function of the manipulation request and a type of the target item and the associated items.
